(19) United States
(12) Patent Application Publication
(10) Pub. No.: US 2014/0037110 A1
(43) Pub. Date: Feb. 6, 2014

(54) METHOD AND DEVICE FOR FORMING A DIGITAL AUDIO MIXED SIGNAL, METHOD AND DEVICE FOR SEPARATING SIGNALS, AND CORRESPONDING SIGNAL

(71) Applicants: Laurent Girin, Granoble (FR); Antoine Liuktus, Paris (FR); Gael Richard, Viroflay (FR); Roland Badeau, Paris (FR)

(72) Inventors: Laurent Girin, Granoble (FR); Antoine Liuktus, Paris (FR); Gael Richard, Viroflay (FR); Roland Badeau, Paris (FR)

(73) Assignees: Telecom Paris Tech, Paris Cedex 13 (FR); INSTITUT POLYTECHNIQUE DE GRENOBLE, Grenoble (FR)

(21) Appl. No.: 13/879,381

(22) PCT Filed: Oct. 11, 2011
(86) PCT No.: PCT/EP11/67730

§ 371 Date: Sep. 23, 2013

(30) Foreign Application Priority Data
Oct. 13, 2010 (FR) 1058348

(51) Int. Cl. G10L 19/018

(52) U.S. Cl. CPC G10L 19/018
USPC 381/119

(57) ABSTRACT

The invention relates to a method of forming one or more digital audio mixed signals (Sₒᵤₜ) on the basis of at least two digital audio source signals (S₁, S₂), in which the digital audio mixed signal or signals are formed by mixing the digital audio source signals. A characteristic digital magnitude of at least one digital audio source signal is compressed into a series of bits and said series of bits is inserted into said digital audio source signal or into the digital audio mixed signals in an almost inaudible or inaudible manner, The characteristic digital magnitude is the temporal, spectral or spectro-temporal distribution of said digital audio source signal or the temporal, spectral or spectro-temporal contribution of said digital audio source signal in the mixed signal or signals, or said digital audio source signal. The invention also relates to a method of separation intended for separating, at least partially, at least one digital audio source signal contained in one or more digital audio mixed signals obtained previously. The invention also relates to the corresponding digital audio mixed signal (Sₒᵤₜ), as well as to the corresponding devices.

The present invention relates to a method intended to separate at least one of the source signals making up an overall digital audio signal. The invention also relates to a method for forming an overall digital audio signal that makes it possible to subsequently separate at least one of its component source signals. Finally, the invention relates to the devices intended to implement these methods.

Mixing signals consists in aggregating a plurality of signals, called source signals, to obtain one or more composite signals, called mixed signals. In audio applications in particular, the mixing may consist of a simple step of adding together the source signals or may also comprise steps of filtering the signals before and/or after the addition. Moreover, for some applications such as audio compact disc applications, the source signals may be mixed differently to form two mixed signals corresponding to the two channels (left and right) of a stereo. signal.

The separation of sources consists in estimating the source signals from the observation of a certain number of different mixed signals formed from these same source signals. The objective is generally to boost, even if possible to fully extract one or more target source signals. The separation of sources is particularly difficult in the so-called “underdetermined” cases in which the number of mixed signals available is less than the number of the source signals present in the mixed signals. The extraction is in this case very difficult, even impossible, because of the small quantity of information available in these mixed signals compared to that present in the source signals. The music signals on an audio compact disc are a particularly representative example thereof because there are only two stereo channels (that is to say two left and right mixed signals), generally very redundant, for a potentially large number of source signals.

There are a number of types of approaches in the separation of source signals including blind separation, computational auditory scene analysis and model-based separation. Blind separation is the most general form, in which no information on the source signals or on the nature of the mixed signals is known beforehand. A certain number of assumptions are then made concerning these source signals and the mixed signals (for example that the source signals are statistically independent) and the parameters of a separation system are estimated by maximizing a criterion based on these assumptions (for example by maximizing the independence of the signals obtained by the separation device). However, this method is used generally in the case where there are many mixed signals available (at least as many as there are source signals) and is therefore not applicable to the underdetermined cases in which the number of mixed signals is less than the number of source signals.

Computational auditory scene analysis consists in modeling the source signals as harmonic partials, but the mixed signal is not explicitly broken down. This method is based on the mechanisms of the human auditory system for separating the source signals in the same way as our ears do. The following can notably be cited: D. P. W. Ellis, Using knowledge to organize sound: The prediction-driven approach to computational auditory scene analysis, and its application to speech/non-speech mixture (Speech Communication, 27(3), pp. 281-298, 1999), D. Godsmark and G. J. Brown, A blackboard architecture for computational auditory scene analysis (Speech Communication, 27(3), pp. 351-366, 1999), as well as T. Kinoshita, S. Sakai, and H. Tanaka; Musical sound source identification based on frequency component adaptation (In Proc. IJCAI Workshop on CASA, pp. 18-24, 1999). However, computational auditory scene analysis generally leads to poor results in the separation of source signals, particularly in the case of audio signals.

Another form of separation relies on a decomposition of the mixture on the basis of matched functions. There are two major categories thereof: time-domain parsimonious decomposition and frequency-domain parsimonious decomposition.

The first entails decomposing the waveform of the mixture, and the other entails decomposing its spectral representation, into a sum of elementary functions called “atoms”, elements of a dictionary. Various algorithms make it possible to choose the type of dictionary and the most likely corresponding decomposition. For the time domain, the following can in particular be cited: L. Benaroya, Représentations parcimonieuses pour la separation de sources avec un seul capteur (Proc. GRETSI, 2001), or P. J. Wolfe and S. J. Godsill, A Gabor regression scheme for audio signal analysis (Proc. IEEE Workshop on Applications of Signal Processing to Audio and Acoustics, pp. 103-106, 2003). In the method proposed by Gribonval (R. Gribonval and E. Bacry, Harmonic Decomposition of Audio Signals With Matching Pursuit, IEEE Trans. Signal Proc., 51(1), pp. 101-112, 2003), the decomposition atoms are classified in independent subspaces, which makes it possible to extract groups of harmonic partials. One of the restrictions in this method is that generic dictionaries of atoms such as the Gabor atoms for example, not matched to the signals, do not give good results. Furthermore, for these decompositions to be effective, the dictionary must contain all the translated forms of the waveforms of each type of instrument. The decomposition dictionaries therefore have to be extremely voluminous for the projection and therefore the separation to be effective.

To mitigate this problem of invariance through translation which appears in the time domain case, there are frequency-domain parsimonious decomposition approaches. The following can in particular be cited: M. A. Casey and A. Westner (Separation of mixed audio sources by independent subspace analysis, Proc. Int. Computer Music Conf., 2000), who have introduced independent subspace analysis (ISA). This analysis consists in decomposing the short-term amplitude spectrum of the mixed signal (computed by short-term Fourier transform (TFCT)) on a basis of atoms, and then recombining the atoms into independent subspaces, each subspace being specific to a source, in order to then resynthesize the sources separately. However, this approach is generally limited by a number of factors: the resolution of the spectral analysis by TFCT, the superposition of the sources in this spectral domain, and the restriction of the spectral separation to the amplitude (the phase of the resynthesized signals being that of the mixed signal). It is thus generally difficult to represent the mixed signal as a sum of independent subspaces because of the complexity of the sound scene in the spectral domain (strong interleaving of the different components) and because of the trend, as a function of time, of the contribution of each component in the mixed signal. In fact, the methods are often evaluated on well-controlled “simplified” mixed signals (the source signals are MIDI instruments or are instruments that can be relatively well separated, fairly few in number).

The following can also be cited: L. Benaroya, F. Bimbot and R. Gribonval Audio sources separation with a single sensor (IEEE Trans. Audio, Speech, & Language Proc., 14(1), 2006) who use statistical models of the different sources. However, the parameters of these models are set on the basis of examples of audio tracks of the different instruments to be separated.

S. D. Teddy and E. Lai, Model-based approach to separating instrumental music from single track recordings (Int. Conf. Control, Automation, Robotics and Vision, Kunming, China, 2004) use a neural network to “learn” the characteristics of various musical instruments.

They extract auditory characteristic from the timbre of the piano using an auditory image model, then try to reveal these characteristics in the mixture in order to isolate the piano.

K. I. Molla and K. Hirose, Single-Mixture audio source separation by subspace decomposition of Hilbert spectrum (IEEE Trans. Audio, Speech, & Language Proc., 15(3), 2007) have worked on a separation of sources by a decomposition of the Hilbert spectrum of the mixture into independent subspaces, the Hilbert transform giving better results in discrimination of the different sources than the Fourier transform.

N. Cho, Y. Shiu and C. C. J. Kuo, Audio source separation with matching pursuit and content-adaptative dictionaries (IEEE Workshop on Applications of Signal Processing to Audio and Acoustics, 2007) propose a separation by decomposition of the mixture on a basis of Gabor atoms learned for a particular instrument, and for the different notes of the instrument. By a “matching pursuit” technique, some of these atoms are retained then gathered together in a subspace matched to the extracted note.

Another type of decomposition consists in modeling the power spectrogram of each source as the sum of a plurality of non-negative spectral forms. The following can be cited: A. Ozerov and C. Févotte, Multichannel nonnegative matrix factorization in convolutive mixtures for audio source separation (IEEE Trans. on Audio, Speech and Lang. Proc. Vol 18, no. 3, March 2010) for a general presentation. This decomposition is done by factorization into non-negative matrices. The main drawbacks of such a decomposition are that the spectrograms of the sources have to exhibit a low spectral variability for the separation to be effective, which is rarely the case for real signals. For the voice signal for example, the vibrato phenomena constantly cause this constraint to be violated. Other systems such as J. L. Durrieu, G. Richard, B. David and C. Févotte, Source/Filter Model for Main Melody Extraction From Polyphonic Audio Signals (IEEE Transactions on Audio, Speech and Language Processing, vol. 18, no 3, March 2010) have also been proposed.

Finally, Y. W. Liu, Sound source segregation assisted by audio watermarking (IEEE, Int. Conf. Multimedia and Expo., pages 200-203, 2007) proposes marking the source signals with an identification of the signal source from which they are derived. In particular, the marking is done in such a way as to separate, in the frequency spectrum of the mixed signal, the frequencies derived from each source signal. However, the number of sources that can thus be separated is limited. Furthermore, it is not conceivable to mark all the frequencies contained in a source signal: there may then be a superposition of a non-marked frequency of one source signal with a marked frequency of the other source signal, thus resulting in estimation errors that are reflected on the result of the separation.

For all these studies, the tests are performed on rather unrealistic artificial mixtures and in conditions that are very controlled compared to the real cases to which they are intended to be applied. In all the cases, the tests are generally not carried out on signals of several minutes. Moreover, the methods presented hereinabove concentrated on the case of a single mixture and take no account of the case of stereo mixtures.

Also, the separation methods based on underdetermined mixtures exhibit a limited effectiveness because of the lack of available information, other than that supplied by the mixed signals themselves.

One aim of the present invention is therefore to propose a method that makes it possible to separate a source signal contained in one or more mixed signals, more effectively. In particular, one aim of the invention is to propose a method for separating a source signal in the so-called “underdetermined” cases in which there are fewer mixed signals than there are source signals. One aim of the invention is to propose a method that makes it possible to separate a source signal contained in one or more mixed signals, using information of reduced size.

To this end, in one embodiment, a method for forming one or more digital audio mixed signals from at least two digital audio source signals is proposed, in which the digital audio mixed signal or signals is/are formed by mixing the digital audio source signals. A digital characteristic quantity of at least one digital audio source signal is compressed into a series of bits, and said series of bits is inserted into said digital audio source signal or into the digital audio mixed signal or signals, inaudibly or almost inaudibly. The digital characteristic quantity is the temporal, spectral or spectro-temporal distribution of said digital audio source signal or the temporal, spectral or spectro-temporal contribution of said digital audio source signal in the mixed signal or signals, or said digital audio source signal.

A separation method is also proposed, intended to separate, at least partially, at least one digital audio source signal contained in one or more digital audio mixed signals obtained previously. According to the method, the series of bits is extracted from the audio mixed signal or signals, then the series of bits is transformed into a decompressed digital characteristic quantity so as to obtain, at least partially, said digital audio source signal, or else the series of bits is extracted from the audio mixed signal or signals, the series of bits is transformed into a decompressed digital characteristic quantity then the mixed signal or signals is/are processed according to said decompressed digital characteristic quantity so as to to obtain, at least partially, said audio digital audio source signal. The transformation of the series of bits into a decompressed digital characteristic quantity can be an audio decompression or an image decompression.

The association of source compression, insertion and separation methods makes it possible to improve the effectiveness of the separation of a source signal from one or more mixed signals, in as much as it is an informed separation: at the time of the separation, information on at least one source signal is known before mixing. In particular, in the so-called “underdetermined” cases, even with just one mixed signal, the separation remains possible by virtue of the information relating to the source signals themselves, which is inserted into the mixed signal, and even with a high number of source signals.

The digital compression, or source coding, consists in transforming a series of bits representing a digital quantity into a shorter series of bits, forming a compressed quantity. The decompression (or decoding) is the reverse transformation making it possible to restore (just as in the case without loss, and with a degradation in the case with losses) the decompressed initial quantity from the reduced series of bits. The quality of the compression, that is to say the fidelity of the quantity compressed then decompressed relative to the initial quantity, depends in particular on the type of compression and on the size of the compressed quantity. Thus, in the present invention, the digital characteristic quantity of at least one source signal is compressed, that is to say is transformed into a series of bits (into a compressed digital characteristic quantity) comprising fewer bits than the initial (non compressed) digital characteristic quantity. In particular, the series of bits will be able to have a number of bits two times, preferentially five times, and even more preferentially ten times less than the number of bits of the characteristic quantity. Depending on the size available for inserting the compressed digital characteristic quantity into the mixed signal and/or on the desired quality for the separation of the source signals, the compression of the characteristic quantity will be able to be performed by a lossless algorithm or by a lossy algorithm. In the latter case, different settings can if necessary make it possible to control the trade-off between the size of the compressed information and the quality of the fidelity of the decompressed digital characteristic quantity. The compression/decompression makes it possible to augment the quality of the separation of the source signals, for one and the same capacity to insert information into the mixed signal or signals. It is then possible to obtain compressed quantities and decompressed quantities rapidly, with controllable sizes, in particular small, while retaining an effective separation.

The temporal, spectral or spectro-temporal distribution of the source signals can be in modulus or energy terms. Similarly, the temporal, spectral or spectro-temporal contribution of the source signals in the mixed signal or signals can be in percentage terms and represent the contribution in energy or modulus terms of the source signals in the mixed signal or signals. Preferentially, these quantities are positive real values.

According to one implementation, the digital characteristic quantity of the signal source is said digital audio source signal, and said digital audio source signal is compressed by an audio compression means.

According to this implementation, a source signal is used as characteristic quantity. The source signal can then be compressed by an algorithm suitable for compressing a quantity with a variable. In particular, the compression step can be implemented by an audio compression means. The audio compression may comprise a transformation in the time-frequency plane, a scalar quantization of the transform taking account if necessary of the auditory perception of the signal) and an entropic coding. The audio compression can thus be chosen from the MP3 or AAC algorithms.

According to another implementation, the digital characteristic quantity of the digital audio source signal is the spectro-temporal distribution of the source signal or the spectro-temporal contribution of said audio source signal in the mixed signal or signals, and said digital characteristic quantity is compressed by an image compression means.

The spectro-temporal distribution or contribution of the digital audio source signal is information of the type of time-frequency representation of said source signal. It is here a quantity expressed in modulus or energy terms. Such a representation entails representing in terms of energy or modulus of the amplitude (that is to say the square root of the energy), the source signal as a function of two parameters, time and frequency. This corresponds to the trend, in energy or modulus terms, of the frequency content of the source signal as a function of time. There is thus obtained, for a given instant and a given frequency, a real positive value corresponding to the components of the signal at this frequency and at this instant.

Examples of theoretical formulations and of practical implementations of time-frequency representations have already been described (L. Cohen: Time-Frequency Distributions, a Review, Proceedings of the IEEE, vol. 77, N^{o} 7, 1989; F. Hlawatsch, F. Auger: Temps-fréquence, concepts et outils, Hermès Science, Lavoisier 2005; P. Flandrin: Temps Fréquence, Hermès Science, 1998).

The spectro-temporal distribution or contribution of the digital audio source signal supplying positive real values as a function of time and frequency, it can then be compressed by an algorithm suitable for compressing a quantity with two variables. In particular, the compression step can be implemented by an image compression means. In practice, the spectro-temporal distribution or contribution of the digital audio source signal, consisting of positive real values, can be considered as an image, then compressed by using an image compression algorithm, for example based on a quantization of discrete cosine or wavelet transform coefficients. The image compression consists in representing a two-dimensional information item (the grey levels or the color levels of the pixels of an image) into a series of bits having fewer bits than that of the representation of the initial image (without compression). The image compression may comprise a transformation of the two-dimensional information (for example: time (abscissa)—frequency (ordinate)) to a two-dimensional frequency space (for example: frequency of the information on the×axis and frequency of the information on the y axis), a scalar quantization of the coefficients of the two-dimensional frequency space (taking account if necessary of the visual perception) and an entropic coding. The image compression can thus be the JPEG algorithm. The decompression (or decoding) makes it possible to restore the spectro-temporal distribution or contribution of the decompressed digital audio source signal from the reduced series of bits. Numerous algorithms are available for performing such processing (J. Woods: Multidimensional Signal, Image and Video Processing and. Coding, Academic press 2006; R. Gonzales, R. Woods: Digital Image Processing, Prentice Hall, 2007). The application of image compression algorithms to the two-dimensional values of the spectro-temporal distribution or contribution of the digital audio source signal can if necessary comprise a renormalization of these values in a range usually used for the image compression. In the decompression, the corresponding denormalization is then if necessary applied.

According to one embodiment, the spectro-temporal distribution of the source signal or the spectro-temporal contribution of said audio source signal in the mixed signal or signals is transformed into a logarithmic scale before being compressed by the audio or image compression means.

Thus, according to the invention, the image compression algorithms are used not for photographs or drawings, but on time-frequency representations, in modulus or energy terms, of an audio signal. The use of the techniques implemented for images in the audio processing domain makes it possible to improve the processing of the audio signals, while benefiting from the power of the image compression algorithms.

The series of bits resulting from the compression of the characteristic quantities of the audio source signals can be inserted by watermarking into the source signal or signals before mixing and/or into the mixed signal or signals after mixing.

Watermarking consists, in its most general form, in inserting binary information into a digital signal.

Hereinbelow, the audio watermarking techniques will be considered. The watermarking of a signal exploits the defects of the human perceptive system to insert into a signal, in this case a sound signal, information which is preferably imperceptible, that is to say inaudible. Typically, the techniques employed are of spectral spreading type (R. Garcia: Digital watermarking of audio signals using psychoacoustic auditory model and spread spectrum theory, 107th Convention of Audio Engineering Society (AES), 1999), (Cox, I. J., Kilian, J., Leighton, F. T., Shamoon, T.: Secure spread spectrum watermarking for multimedia, IEEE Transactions on Image Processing, 6(12), pp.1673-1687, 1997). Generally, audio watermarking is used in the context of protecting and controlling authors' rights (Digital Rights Management) for works on a digital medium, and more generally in the context of the traceability of information on this type of medium. It is thus possible to watermark on a song information making it possible to identify the author or the owner of the song. In this case, the aim is to very robustly (that is to say, in a way resistant to possible more or less legal manipulations of the signal) insert an information item of relatively small quantity and spread within a wide time-frequency band of the signal then added thereto, so that it is very difficult to be able to isolate it in order to eliminate it.

When the host signal is recognized because of the sender (where the watermarking is formed), this can be termed “informed watermarking” (or watermarking with side-information). The aim is in this case to choose an optimum watermarking suited to the signal on which it is inserted (I. J. Cox, M. L. Miller and A. L. McKellips, Watermarking as communications with side information, IEEE Proc., 87(7), pp. 1127-1141, 1999). The constraints to be satisfied are to obtain a transmission bit rate that is as high as possible without the watermarking being in the least audible, and also to ensure the best possible reliability of transmission (few errors made during transmission). Watermarking for data transmission is thus used, among other things, for annotating documents with a view, for example, to indexing in a database (Ryuki Tachibana: Audio watermarking for live performance, SPIE Electronic Imaging: Security and Watermarking of Multimedia Content V, volume 5020, pp. 32-43, 2003), or the identification of documents in order to establish statistics on the broadcasting of this document for example (T. Nakamura, R. Tachibana & S. Kobayashi, Automatic music monitoring and boundary detection for broadcast using audio watermarking, SPIE Electronic Imaging: Security and Watermarking of Multimedia Content IV, vol 4675, pp. 170-180, 2002). In the context of watermarking for data transmission, it is also possible to cite the technique of substitutive watermarking in which the characteristics of the host signal are replaced by those of the watermark. Examples of substitutive watermarkings are described by Chen (B. Chen and C. E. W. Sundberg: Digital audio broadcasting in the fm band by means of contiguous band insertion and precanceling techniques, IEEE Transactions on Communications, 48(10), pp. 1634-1637, 2000), or even by Bourcet (P. Bourcet, D. Masse and B. Jahan: Système de diffusion de données, (Data broadcasting system), 1995. Patent of invention 95 06727, Télédiffusion de France).

In the present case, it is possible to use a watermarking scheme inspired by the works of Chen and Wornell (B. Chen & G. Wornell, Quantization index modulation: a class of provably good methods for digital watermarking and information embedding. IEEE Trans. Information Theory, 47, pp. 1423-1443, 2001). In these works, the watermarking is introduced by quantization. To put it simply, the watermarking is borne by a modification of the quantization levels, in one of the representations of the host signal (temporal, spectral or spectro-temporal representation). The theoretical performance levels of this technique come close to the Costa model (M. Costa, Writing on dirty paper, IEEE Trans. Information Theory, 29, pp. 439-441, 1983) which sets the theoretical limit of the transmission capacity of a transmission chain if the signal is recognized beforehand because of the sender.

In the present case, the watermarking is used to insert a compressed information item relating to the signal itself, making it possible to separate the source signals from the mixed signal. The information inserted here relates to the source signals themselves (for example their distribution in time, in frequency, or even in the time-frequency plane, or else the source signal itself), to the source signals and the mixed signal (for example the contribution of each source signal in the mixed signal). It thus concerns characteristic quantities of the source signals, that is to say characteristic descriptors of the source signals in the signal processing sense, and these descriptors must make it possible to aid in the separation of the signals. It is therefore here information that is both relatively voluminous, before compression, and possibly distributed in a well localized and well controlled manner in the time-frequency plane. On the other hand, the watermarking does not need to have particular properties of robustness, notably with respect to potential illegal manipulations. It is thus possible to consider, as watermarking methods, methods of non-security type, that is to say methods that are not very robust to manipulations of the signal but that make it possible to watermark information in greater quantities.

The series of bits (compressed quantity) is watermarked in the signal or signals in such a way as to modify the signal very little and in such a way as to not modify its format. In particular, in the case of audio signals, the watermarked signal remains compatible with the initial non-watermarked signal or signals, for example if both the watermarked and non-watermarked versions of the signal or signals are in audio CD format, the two versions can be played back by a conventional compact disc player, and the watermarked value is inserted in such a way as to be inaudible or almost inaudible. It is then possible to read the watermarked signal or signals according to methods already known, even if the separation of the signals is not undertaken by these methods.

According to another implementation, the series of bits (compressed quantity) can be inserted into one or more dedicated digital segments of the mixed signal or signals.

In this case, the functional segments of the mixed signal or signals are used, that is to say the segments transmitting functional information and not information as signal (the signal or signals resulting from the mixing of the source signals). The functional information refers to the technical characteristics of the forming device and of the separation device, and not only to the information to be transmitted as signal.

According to another implementation, the series of bits (compressed quantity) can be inserted into one or more dedicated digital streams of the mixed signal or signals. In this case, it is considered that the mixed signal or signals comprise a plurality of digital streams. One or more of these digital streams are used to transmit the signal or signals resulting from the mixing of the source signals, and one or more of the other digital streams can be used to transmit the series of bits. It is thus possible to obtain one or more streams for transmitting information as signal (the signal or signals resulting from the mixing of the source signals) and one or more streams for transmitting functional information (notably the characteristic quantities of the compressed source signals) to separate one or more source signals from the mixed signal or signals.

According to another aspect, a device for forming one or more digital audio mixed signals from at least two digital audio source signals is proposed, comprising a means for mixing said digital audio source signals to form the digital audio mixed signal or signals. The device also comprises a compression means capable of compressing a digital characteristic quantity of at least one audio source signal into a series of bits, and a means for inserting said series of bits into said audio source signal or into the audio mixed signal or signals inaudibly or almost inaudibly. The digital characteristic quantity is the temporal, spectral or spectro-temporal distribution of said source signal or the temporal, spectral or spectro-temporal contribution of said source signal in the mixed signal or signals, or said digital audio source signal.

A separation device is also proposed that is intended to separate, at least partially, at least one digital source signal contained in one or more digital audio mixed signals outgoing from the preceding device, comprising a means for extracting the series of bits representing the compressed digital characteristic quantity and a means for decompressing the series of bits into a decompressed digital characteristic quantity suitable for obtaining, at least partially, said digital audio source signal, or a means for decompressing the series of bits into a decompressed digital characteristic quantity and a means for processing the digital audio mixed signal or signals according to the decompressed digital characteristic quantity suitable for obtaining, at least partially, said digital audio source signal. The decompression means can be an audio decompression means or an image decompression means.

According to one embodiment of the forming device, the digital characteristic quantity of the source signal can be said digital audio source signal, and the compression means can be an audio compression means.

According to another embodiment of the forming device, the digital characteristic quantity of the digital audio source signal can be the spectro-temporal energy distribution of said digital audio source signal, or the spectro-temporal energy contribution of said digital audio source signal in the digital audio mixed signal or signals, and the compression means can be an image compression means.

According to one embodiment of the forming device, the insertion means is a watermarking means mounted upstream of the mixing means and is capable of watermarking the series of bits on the source signal or signals.

According to another embodiment of the forming device, the insertion means is a watermarking means mounted downstream of the mixing means and is capable of watermarking the series of bits on the mixed signal or signals.

The forming device may also comprise a means for quantizing a representation of a signal, in which the watermarking means inserts the series of bits by using over-levels of quantization of the representation of the signal. The representation of the signal can be a spectral or spectro-temporal representation of the signal.

In particular, the quantization means makes it possible to determine the amplitude of the modifications that may be introduced into the representation of the signal, in such a way that these modifications do not alter the perceived quality of the signal when the latter is played back by a conventional reading device or by a separation device according to the invention, and in such a way that these modifications can be detected by a separation device according to the invention.

It is thus possible to obtain one or more signals watermarked with a series of bits, such that the quality of the sound content represented by this or these watermarked signal(s) is little or not at all degraded relative to that of the sound content represented by the initial signal or signals. The playback of the watermarked signal or signals by a known device will make it possible to obtain a quality of the sound content that is little or not at all modified, whereas the processing of the watermarked signal by a device according to the invention will make it possible to determine the series of bits in the signal.

Alternatively, the insertion means can be capable of inserting the series of bits into one or more dedicated digital segments of the nixed signal or signals or into one or more dedicated digital streams of the mixed signal or signals.

According to another aspect, one or more digital audio mixed signals are proposed that are obtained by mixing at least two digital audio source signals, comprising a barely audible or inaudible series of bits corresponding to a digital characteristic quantity of at least one digital audio source signal, the digital characteristic quantity being the temporal, spectral or spectro-temporal distribution of said signal source or the temporal, spectral or spectro-temporal contribution of said signal source in the mixed signal or signals, or said digital audio source signal. The barely audible or audible series of bits can be obtained by an audio or image compression of the digital characteristic quantity of at least one digital audio source signal.

An information medium is also proposed, notably an audio compact disc, comprising the digital audio mixed signal or signals according to the preceding claim.

The invention will be better understood on studying a particular embodiment, taken as a nonlimiting example and illustrated by the appended drawings, in which:

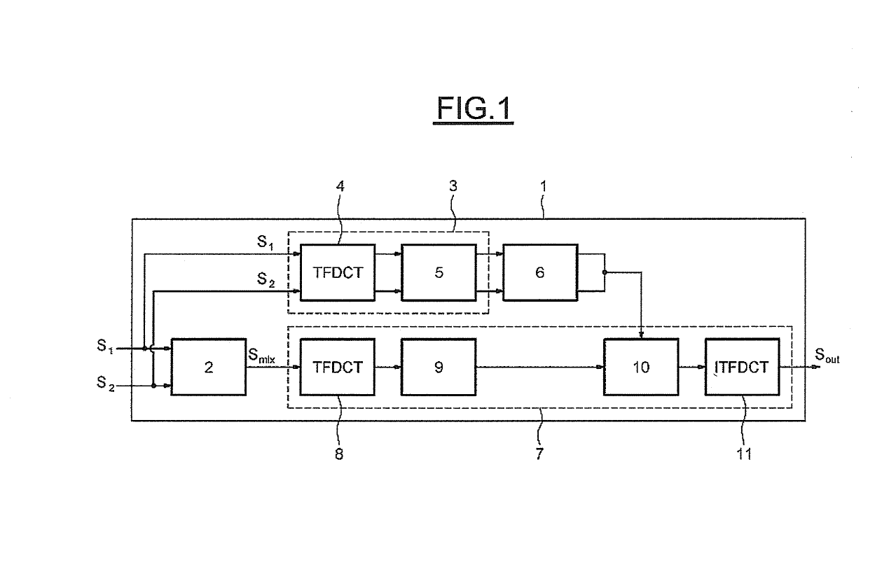

FIG. 1 schematically represents a first embodiment of a device for forming a mixed signal according to the invention;

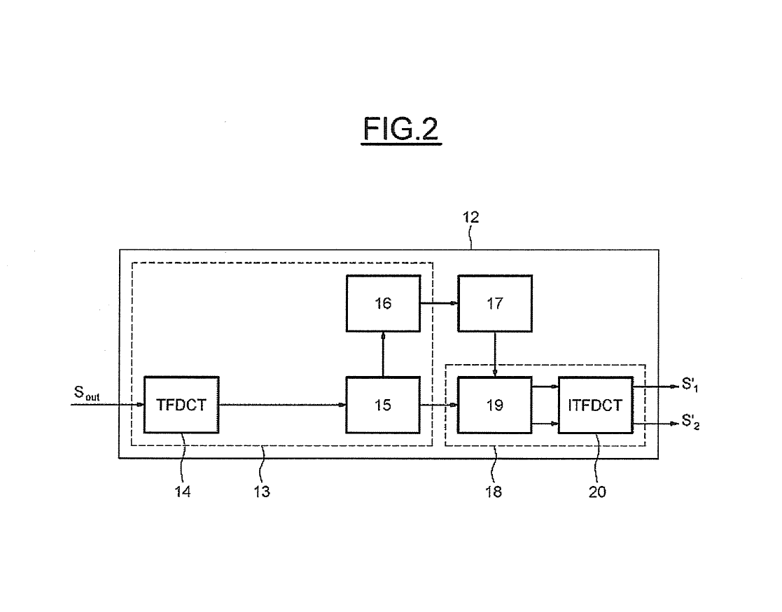

FIG. 2 schematically represents a first embodiment of a separation device according to the invention;

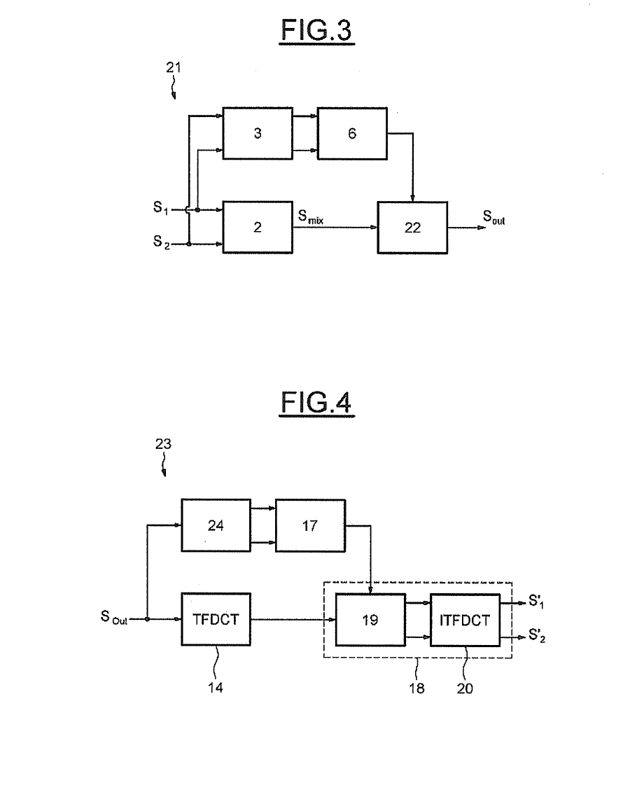

FIG. 3 schematically represents a second embodiment of a device for forming a mixed signal according to the invention;

FIG. 4 schematically represents a second embodiment of a separation device according to the invention;

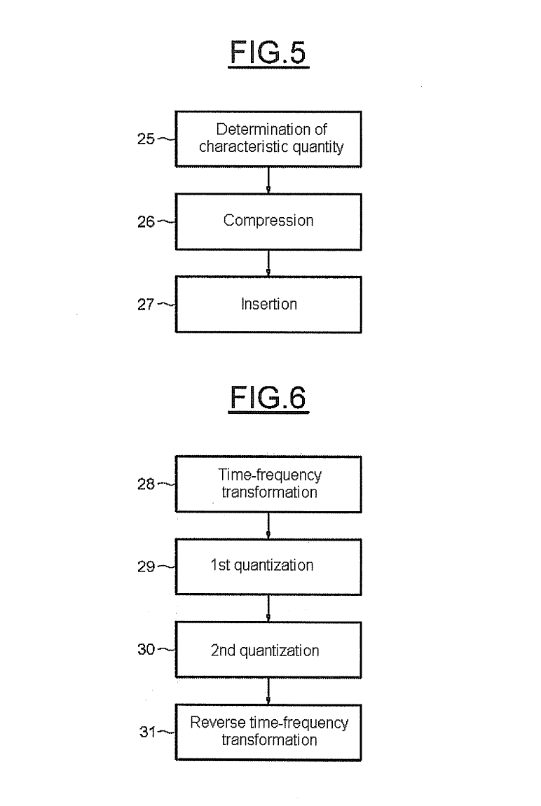

FIG. 5 is a flow diagram of a method for forming a mixed signal according to the invention;

FIG. 6 is a flow diagram of a watermarking method, and

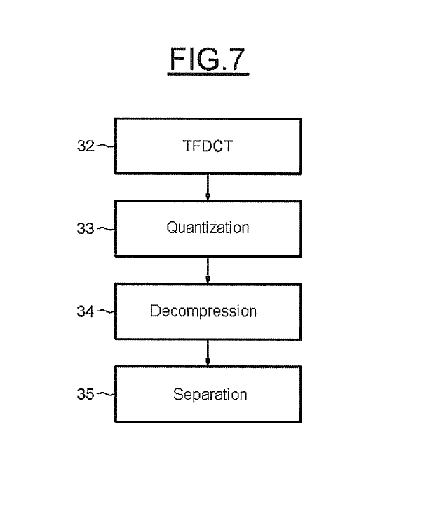

FIG. 7 is a flow diagram of a separation method according to the invention.

FIG. 1 schematically shows a first embodiment of the device 1 for forming a mixed signal. The forming device 1 receives as input the source signals S₁ and S₂, and delivers a mixed signal Sₒᵤₜ. For the purposes of simplicity, the number of source signals is limited here to two and the number of mixed signals is limited to one. However, it will be understood that the number of source signals can be much higher, and the number of mixed signals is generally two. Moreover, it is considered hereinafter in the description that the signals are audio signals. The purpose of the forming device 1 is to deliver a mixed signal Sₒᵤₜ formed from source signals S₁, S₂ and comprising a series of bits corresponding to the compression of a characteristic quantity of at least one of the source signals. It is considered hereinafter in the description that the mixed signal Sₒᵤₜ comprises the series of bits corresponding to the compression of the characteristic quantities of the two source signals S₁ and S₂.

The device comprises a mixing means 2. The mixing means also receives as input the source signals S₁ and S₂, and delivers as output an initial mixed signal Sₘᵢₓ resulting from a combination of the source signals. In particular, the mixing may consist of a simple aggregation. It may also be an aggregation in which the coefficients assigned to each source signal vary in time, or even an aggregation associated with one or more filters.

The forming device 1 comprises a means 3 for determining a characteristic signal quantity. The determination means 3 receives as input the source signals for which the value of the characteristic quantity is to be determined, in this case the two signals S₁ and S₂.

Hereinafter in the description, a determination means 3 is chosen that is capable of determining, as characteristic quantity, the spectro-temporal distribution of the energy of the signal concerned. The determination means 3 thus comprises a means 4 for transforming the source signal, so as to obtain the representation of the source signal in a time-frequency plane. The time-frequency transformation of the signal can be performed by a short-term discrete Fourier transform (TFDCT). The source signal is then represented by the set of coefficients of this TFDCT, converted to square modulus to obtain an energy representation. There is then obtained a representation of the source signal in the form of a matrix comprising positive real numbers. It is this time-frequency representation which will be compressed to obtain a series of bits corresponding to the compression of the characteristic quantity of the source signal. Moreover, the determination means 3 may also comprise a detection means 5 making it possible to process the matrix obtained, that is to say making it possible to apply an active processing to the matrix obtained, for example a segmentation or a filter.

The detection means 5 may for example, for each source signal S₁, S₂, consider only the coefficients of the matrix time-frequency representation corresponding to a certain time interval and to a certain frequency interval. A matrix is thus obtained that contains only the coefficients considered to be relevant by the detection means 5 in characterizing each source signal. The coefficients considered to be non-relevant and which unnecessarily increase the quantity of information to be transmitted to the separation device are thus eliminated, for example the coefficients corresponding to the frequencies that are not audible to the human ear, or the coefficients corresponding to time intervals in which the corresponding source signal has zero values (that is to say, the silent portions of the source signal).

More generally, the detection means 5 may, for example, for each source signal S₁, S₂, consider the coefficients of the matrix time-frequency representation as in groups of adjacent coefficients, hereinafter called sub-blocks. The sub-blocks are matrices representative of only a part of the overall spectro-temporal representation, for example parts where the coefficients are non-zero, and possibly parts where the coefficients are zero. The spectro-temporal representation is then divided up into sub-blocks which will then be able to be compressed jointly or separately more effectively (notably with individualized settings of the compression means).

There are thus obtained, at the output of the determination means 3, a characteristic quantity of the source signal S₁, and a characteristic quantity of the source signal S₂, which are then transmitted to a compression means 6.

The compression means 6 makes it possible to compress the matrix or matrices obtained by the determination means 3. In particular, the compression means 6 makes it possible to obtain a series of bits corresponding to the characteristic quantity of each source signal, which can be their overall spectro-temporal representation or sub-blocks of their spectro-temporal representation. The compression means 6 receives these representations and compresses them by a compression algorithm intended for the signals with two variables, for example an image compression algorithm.

The series of bits will be inserted initially onto the initial mixed signal Sₘᵢₓ to form the mixed signal Sₒᵤₜ, then will be used in a second stage to separate the source signals S₁, S₂ from the mixed signal Sₒᵤₜ.

Alternatively, the characteristic quantity of a source signal may be said audio source signal itself. In this case, there is no transformation means 4 and the detection means 5 may make it possible, for example, to detect and segment the temporal portions where the source signal is non-zero and has to be compressed. The compression means 6 receives the audio source signal or signals possibly segmented by the detection means 5, and compresses them by a compression algorithm intended for the signals with a variable, for example audio, so as to obtain a series of bits corresponding to the compression of the audio source signal or signals.

The forming device 1 also comprises an insertion means 7. The insertion means 7 receives as input the mixed signal Sₘᵢₓ and the series of bits corresponding to the compression of the characteristic quantities of the source signals S₁, S₂.

The insertion means 7 can be a watermarking means capable of watermarking the series of bits on the mixed signal. In order to improve the watermarking and the recovery of the series of bits, the watermarking means may comprise a transformation means 8 making it possible to decompose the initial mixed signal Sₘᵢₓ according to a time-frequency representation which can be the same as that used to decompose the source signals S₁ and S₂ (a TFDCT) or else which may be another time-frequency representation better suited to the watermarking task (for example a modified discrete cosine transform (MDCT)).

The decomposed initial mixed signal is then transmitted to a first quantization means 9. The first quantization means 9 makes it possible to quantize the coefficients of the matrix time-frequency representation of the mixed initial signal, with a first resolution (that is to say, a minimum interval between two quantization values) chosen in such a way as to play back the signal with the desired quality. The minimum interval is chosen according to the perception of the quantization. In the case of audio signals, if the minimum difference between two quantization values is too great, the quantized mixed signal will be perceived differently by the human ear than the initial mixed signal. However, if the minimum difference between two values is sufficiently small, the human ear will not be able to distinguish any difference between the quantized mixed signal and the initial mixed signal.

On the other hand, since the watermarking will be inserted within first quantization intervals, these intervals must also be chosen to be sufficiently wide to be able to insert the most watermarked information therein.

The watermarking means 7 then comprises a second quantization means 10 which receives the quantized time-frequency coefficients of the mixed signal and the series of bits. The second quantization means 10 makes it possible to quantize the coefficients of the matrix representation of the mixed signal with a second resolution greater than the first resolution. The second resolution makes it possible to subdivide the minimum interval of the first quantization, with a second minimum interval, that is to say that it makes it possible to introduce, between the first quantization levels, additional quantization levels (over-levels).

The watermarking principle consists in quantizing the time-frequency coefficients of the mixed signal on the over-levels of the second quantization means 10 according to the values of the series of bits. The watermarking of the series of bits may comprise their segmentation into segments which can be associated with the over-levels, and the quantization of the time-frequency coefficients of the mixed signal by said segments. The distribution and the sequencing of the watermarking of the different segments to be watermarked on the different time-frequency coefficients of the mixed signal can be defined arbitrarily.

Since the watermarking is coded by the over-levels of the second quantization of the means 10, the interval between these over-levels has to be chosen to be sufficiently small to be able to watermark the most possible information. However, if this interval is too small, the value watermarked during the second quantization will not be able to be detected correctly. The value of the interval must ensure a trade-off between detection and information insertion capacity.

Finally, the watermarking means 7 comprises an inverse transformation means 11. The inverse transformation means 11 performs the inverse transformation of that performed by the transformation means 8. It may be a transformation by inverse TFDCT (ITFDCT) or by inverse MDCT (IMDCT) or other depending on the type of transformation chosen for the means 8. A temporal representation of the watermarked mixed signal is then obtained which constitutes the mixed signal Sₒᵤₜ. There is therefore obtained, at the output of the forming device 1, an output mixed signal Sₒᵤₜ with the same temporal representation as the initial mixed signal Sₘᵢₓ, but comprising a watermarking that is barely audible or inaudible and detectable for the source separation. The mixed signal Sₒᵤₜ can then be transmitted or applied to a storage medium. In the case, for example, of a compact disc, the mixed signal Sₒᵤₜ first undergoes a uniform scalar quantization on 16 bits (which corresponds to the audio CD format), then is applied to compact disc. The uniform scalar quantization on 16 bits is a processing example that limits the detection of the second quantization performed by the watermarking means.

A mixed signal Sₒᵤₜ obtained by mixing at least two source signals, and comprising a series of bits corresponding to the compression of a characteristic quantity of at least one of the source signals is thus obtained at the output of the forming device 1. Since the mixed signal Sₒᵤₜ exhibits the same temporal representation as the initial mixed signal Sₘᵢₓ, and the series of bits are inserted in such a way as to be barely audible or inaudible, a conventional device will be able to process the mixed signal Sₒᵤₜ like any mixed signal, whereas a separation device according to the invention, as described below, will be able, in addition, to at least partially separate one of the source signals from the mixed signal Sₒᵤₜ.

FIG. 2 schematically represents a first embodiment of the device for separating a source signal contained in a mixed signal Sₒᵤₜ as defined in the preceding paragraph. The separation device 12 receives as input the mixed signal Sₒᵤₜ, and delivers, in the present case, two at least partially separated source signals S′₁ and S′₂. The aim of the separation device 12 is to deliver, at least partially, one or more source signals contained in a mixed signal Sₒᵤₜ which comprises a compressed value of a characteristic quantity.

The separation device 12 comprises a means 13 for determining series of bits representing the characteristic quantities of the signals to be separated. The means 13 receives as input the mixed signal Sₒᵤₜ and delivers as output the series of bits corresponding to the compression of the characteristic quantities. In the present case, the means 13 delivers the time-frequency representation matrix or matrices of the source signals to be separated compressed or the audio source signal or signals to be separated compressed.

The determination means 13 comprises a transformation means 14 similar to the means 8 described in FIG. 1. The transformation means 14 makes it possible to decompose the mixed signal Sₒᵤₜ into a matrix of time-frequency coefficients (for example TFDCT or MDCT).

The time-frequency coefficients of the mixed signal are then transmitted to a quantization means 15 similar to the means 10 described in FIG. 1. The quantization means 15 makes it possible to quantize the coefficients of the signal Sₒᵤₜ with the same quantifiers as those used in the means 10, and to retrieve the segments of the series of bits by reading quantization over-levels. These segments are then assembled by a concatenation means 16 to retrieve the series of bits representing the characteristic quantities of the compressed source signals.

The series of bits are then transmitted to a decompression means 17 capable of decompressing these series of bits in such a way as to obtain characteristic quantities of the decompressed source signals that are substantially equal to the characteristic quantities of the initial source signals.

The separation device 12 also comprises a processing means 18 receiving the decompressed characteristic quantities from the decompression means 17, and the time-frequency coefficients of the mixed signal determined by the means 13.

Hereinafter in the description, it will be considered that the, characteristic quantities are the spectro-temporal representations of the source signals in energy terms.

The processing means 18 comprises a first separation means 19 capable of separating, at least partially, the source signals from the mixed signal. In particular, the values of the decompressed characteristic quantities are used in combination with the values of the time-frequency coefficients of the mixed signal to perform the separation of the source signals. In as much as the characteristic quantities have been determined from a time-frequency representation of the source signals, it will be possible to retrieve the time-frequency coefficients of the source signals from the characteristic quantities of the source signals and from the time-frequency coefficients of the mixed signal, and therefore apply a separation of the source signals. In particular, if the characteristic quantities are the spectro-temporal representations of the sources in energy terms, it is possible, for each source signal to be separated, to construct a filter, of Wiener filter type, defined, for each point of the time-frequency plane considered, by the ratio of the spectro-temporal representation in energy terms of the source to be separated with the spectro-temporal representation in energy terms of the mixed signal. This filter, once applied to the time-frequency coefficients of the mixed signal, makes it possible to estimate the corresponding time-frequency coefficients of the source signal.

The Wiener filtering makes it possible to obtain an estimation of a signal (in the present case a source signal) mixed with other interfering signals (in the present case, the other source signals), in the sense of the least squares criterion (minimization of the root mean square deviation between samples of the mixed signal and samples of the desired separated signal). The Wiener filters are already described (N. Wiener: Extrapolation, Interpolation, and smoothing of Stationary Time Series: With Engineering applications, The MIT Press, 1950; A. Papoulis: Signal Analysis, McGraw-Hill Companies, 1977; L. Benaroya, F. Bimbot, R. Gribonval: Audio source separation with a single sensor, Speech and Language processing, Vol.14, N^{o} 1, 2006).

The separation method implemented in the separation means 19 can be applied globally to all of the time-frequency plane, or to the level of the sub-blocks defined in the detection means 5. In particular, the separation can be applied only to the sub-blocks for which the coefficients of the spectro-temporal representation in energy terms of the signal to be separated are non-zero or non-negligible.

The time-frequency coefficients of the source signals separated by the separation means 19 are then transmitted to an inverse transformation means 20 similar to the means 11 described in FIG. 1. The means 20 makes it possible to transform the time-frequency coefficients of the separated source signals into temporal signals S′₁ and S′₂ corresponding, at least partially, to the source signals S₁, S₂.

Alternatively, when the series of bits corresponds to the source signals compressed by an audio algorithm, the decompressed characteristic quantities then supply temporal signals S′₁ and S′₂ corresponding, at least partially, to the source signals S₁, S₂. The temporal signals S′₁ and S′₂ are therefore obtained at the output of the decompression means 17. The separation device 12 then does not comprise any processing means 18, but only an inverse transformation means similar to the transformation means 20, receiving as input the time-frequency coefficients of the mixed signal determined by the means 13, and delivering the temporal signal of the mixed signal.

Alternatively, when the series of bits corresponds only to the signal source S₂ compressed by an audio algorithm, the separation device 12 may comprise the processing means 18 with a separation means 19 mounted downstream of the inverse transformation means 20. The separation means 19 receives the temporal signal of the mixed signal from the means 20 as well as the temporal signal S′₂ corresponding, at least partially, to the source signal S₂ from the decompression means 17. The separation means 19 then supplies, as output, the temporal signal S′₁ corresponding, at least partially, to the source signal S₁ by subtraction of the signal S′₂ from the mixed signal.

FIG. 3 shows a second embodiment of a forming device 21 according to the invention. In this embodiment, the elements identical to those of the first embodiment are identified with the same references. The forming device 21 receives as input at least two source signals S₁, S₂ and supplies, as output, a mixed signal Sₒᵤₜ.

The device 21 comprises a mixing means 2 receiving the two source signals S₁, S₂, and supplying an initial mixed signal Sₘᵢₓ.

The device 21 also comprises a determination means 3 receiving as input the source signals S₁ and S₂, and supplying as output the spectro-temporal distributions or contributions of the source signals. The spectro-temporal distributions or contributions of the source signals are then transmitted to a compression means 6 suitable for transforming them into series of bits.

The device 21 finally comprises an insertion means 22 capable of inserting the series of bits determined by the compression means 6 into the initial mixed signal Sₘᵢₓ supplied by the mixing means 2, so as to obtain the mixed signal Sₒᵤₜ. In particular, the insertion means 22 can insert the series of bits into one or more dedicated digital segments of the mixed signal Sₒᵤₜ, or into one or more dedicated digital streams for transmitting the mixed signal Sₒᵤₜ.

Mixed signal Sₒᵤₜ obtained by mixing at least two source signals, and comprising a series of bits corresponding to the compressed spectro-temporal representations of the source signals, is thus obtained at the output of the forming device 21. In particular, unlike a multi-track signal where the information transmitted on each track makes it possible to obtain an audio signal, the series of bits are here determined in such a way as to present small size, and make it possible to obtain a source signal only after decompression and combination with the mixed signal, for example by the application of Wiener filters to the mixed signal. The series of bits transmitted in the dedicated digital segments or in a dedicated digital stream are not sufficient in themselves to retrieve a source signal corresponding substantially to the original source signal, and are therefore considered to be barely audible or inaudible.

FIG. 4 shows a second embodiment of a separation device 23 according to the invention. In this embodiment, the elements that are identical to those of the first embodiment are identified with the same references. The separation device 23 receives as input the mixed signal Sₒᵤₜ and supplies, as output, two signals S′₁, S′₂ corresponding, at least partly, to the original source signals S₁, S₂.

The separation device 23 comprises a means 24 for extracting the series of bits. The means 24 receives as input the signal Sₒᵤₜ either having one or more dedicated digital segments comprising the series of bits, or having a number of digital streams of which one comprises the signal resulting from the mixing of the source signals and one or more other dedicated digital streams comprise the series of bits, and supplies as output the series of bits. The determination of the series of bits can be done directly when the latter is inserted into one or more dedicated digital streams, or may require a processing when the latter is inserted into one or more dedicated digital segments of the mixed signal Sₒᵤₜ.

The series of bits determined by the extraction means 24 are then transmitted to a decompression means 17, in the present case an image decompression means making it possible to obtain, at the output of the means 17, the spectro-temporal representations of the source signals.

The separation device 23 also comprises a transformation means 14 receiving as input the signal Sₒᵤₜ, and supplying as output the time-frequency coefficients of said signal Sₒᵤₜ.

The spectro-temporal representations of the source signals and the time-frequency coefficients of the signal Sₒᵤₜ are then transmitted to a separation means 18 which comprises a processing means 21 and an inverse transformation means 20. The processing means 19, by the application of Wiener filters for example, and the inverse transformation means 20, then make it possible to obtain the source signals S′₁ and S′₂ corresponding substantially to the original source signals S₁ and S₂.

FIG. 5 shows a flow diagram representing the different steps of the method for forming a mixed signal according to the invention.

The method comprises a first step 25 during which a characteristic quantity is determined. Then, during a step 26, the characteristic quantity is compressed to obtain a series of bits. Finally, in the step 27, the series of bits corresponding to the compressed characteristic quantity is inserted into the initial mixed signal in order to obtain the final mixed signal.

FIG. 6 represents a flow diagram of the different steps of an implementation of the insertion step 27 when the latter is performed by watermarking.

The watermarking begins with a step 28 during which the initial mixed signal is decomposed into time-frequency coefficients. The coefficients are then subjected to a first quantization during the step 29, then a second quantization, during the step 30, during which the series of bits corresponding to the characteristic quantity is inserted into the coefficients of the mixed signal.

Finally, the time-frequency coefficients comprising the series of bits undergo an inverse time-frequency transformation, during a step 31 in order to obtain, as output, the temporal representation of the mixed signal.

FIG. 7 shows a flow diagram representing the different steps of the separation method according to the invention.

The method comprises a first step 32 during which the mixed signal is decomposed into time-frequency coefficients. The time-frequency coefficients then undergo a quantization, during a step 33, making it possible to determine the series of bits watermarked on the mixed signal. The series of bits is then decompressed in a step 34 so as to obtain a decompressed characteristic quantity. Finally, from the decompressed characteristic quantity determined in the step 34, the separation, at least partial, of a source signal is performed in the step 35.

In the case of audio signals, it is thus possible to perform, at the output of the separation system of the invention, a certain number of major audio listening checks (volume, tone, effects) independently on the different elements of the sound scene (instruments and voices obtained by the separation device). Furthermore, one of the significant advantages of the proposed technique is that it is perfectly compatible with the usual digital music formats, in particular the PCM non-compressed stereo format as used for the audio CDs: a music CD watermarked with the proposed method can be used as such on any conventional reader (without benefiting from the separation functionalities) without any distinction from a conventional CD by virtue of an inaudible or barely audible watermarking. Alternatively, a specific reader incorporating the separation method according to the invention will obviously be required to be able to perform the audio listening checks.

Other applications concerning the extraction and the boosting of the speech in communication systems can be envisaged. It is possible, for example, to insert the speech signal at the transmitter (when it is produced in good conditions) before its transmission in a channel that might degrade it (or mix it with other signals), to be able to recover this speech signal, from its degraded or mixed form, at the receiver.

1. A method for forming one or more digital audio mixed signals (Sₒᵤₜ) from at least two digital audio source signals (S₁, S₂), in which the digital audio mixed signal or signals is/are formed by mixing the digital audio source signals, characterized in that a digital characteristic quantity of at least one digital audio source signal is compressed into a series of bits, and said series of bits is inserted into said digital audio source signal or into the digital audio mixed signal or signals, inaudibly or almost inaudibly, the digital characteristic quantity being the temporal, spectral or spectro-temporal distribution of said digital audio source signal or the temporal, spectral or spectro-temporal contribution of said digital audio source signal in the digital audio mixed signal or signals, or said digital audio source signal.

2. The forming method as claimed in claim 1, in which the digital characteristic quantity of the signal source is said digital audio source signal (S₁, S₂), and in which said digital audio source signal is compressed by an audio compression means.

3. The forming method as claimed in claim 1, in which the digital characteristic quantity of the digital audio source signal is the spectro-temporal energy distribution of said digital audio source signal (S₁, S₂), or the spectro-temporal energy contribution of said digital audio source signal (S₁, S₂) in the digital audio mixed signal or signals (Sₒᵤₜ), and in which said digital characteristic quantity is compressed by an image compression means.

4. The forming method as claimed in claim 1, in which the series of bits is inserted by watermarking into said source signal (S₁, S₂) before mixing and/or into the mixed signal or signals (Sₒᵤₜ) after mixing.

5. The forming method as claimed in claim 1, in which the series of bits is inserted into one or more dedicated digital segments of the mixed signal or signals (Sₒᵤₜ) or into one or more dedicated digital streams of the mixed signal or signals (Sₒᵤₜ).

6. A separation method intended to separate, at least partially, at least one digital audio source signal contained in one or more digital audio mixed signals (Sₒᵤₜ) obtained as claimed in claim 1, in which the series of bits is extracted from the mixed audio signal or signals (Sₒᵤₜ) and the series of bits is transformed into a decompressed digital characteristic quantity so as to obtain, at least partially, said digital audio source signal (S′₁, S′₂) or the series of bits is transformed into a decompressed digital characteristic quantity then the mixed signal or signals is/are processed according to said decompressed digital characteristic quantity so as to obtain, at least partially, said digital audio source signal (S′₁, S′₂).

7. A device for forming one or more digital audio mixed signals from at least two digital audio source signals, comprising a means (2) for mixing said digital audio source signals to form the digital audio mixed signal or signals, characterized in that the device also comprises a compression means (6) capable of compressing a digital characteristic quantity of at least one audio source signal into a series of bits, and a means (10) for inserting said series of bits into said audio source signal or into the audio mixed signal or signals inaudibly or almost inaudibly, the digital characteristic quantity being the temporal, spectral or spectro-temporal distribution of said source signal or the temporal, spectral or spectro-temporal contribution of said source signal in the mixed signal or signals, or said digital audio source signal.

8. The forming device as claimed in claim 7, in which the digital characteristic quantity of the source signal is said digital audio source signal, and in which the compression means (6) is an audio compression means.

9. The forming device as claimed in claim 7, in which the digital characteristic quantity of said digital audio source signal is the spectro-temporal energy distribution of said digital audio source signal, or the spectro-temporal energy contribution of said digital audio source signal in the digital audio mixed signal or signals, and in which the compression means (6) is an image compression means.

10. The forming device as claimed claim 7, in which the insertion means (10) is capable of watermarking the series of bits in said source signal before mixing and/or in the mixed signal or signals after mixing.

11. The forming device as claimed in claim 7, in which the insertion means (22) is capable of inserting the series of bits into one or more dedicated digital segments of the mixed signal or signals or into one or more dedicated digital streams of the mixed signal or signals.

12. A separation device intended to separate, at least partially, at least one digital source signal contained in one or more digital audio mixed signals outgoing from the device as claimed in claim 7, comprising a means for extracting the series of bits and a means (17) for decompressing the series of bits into a decompressed digital characteristic quantity suitable for obtaining, at least partially, said digital audio source signal (S′₁, S′₂), or a means (17) for decompressing the series of bits into a decompressed digital characteristic quantity and a means (19) for processing the digital audio mixed signal or signals according to the decompressed digital characteristic quantity suitable for obtaining, at least partially, said digital audio source signal (S′₁, S′₂).

13. A digital audio mixed signal (Sₒᵤₜ), obtained by mixing at least two digital audio source signals, comprising a series of bits, inserted inaudibly or almost inaudibly, corresponding to a digital characteristic quantity of at least one digital audio source signal, the digital characteristic quantity being the temporal, spectral or spectro-temporal distribution of said signal source or the temporal, spectral or spectro-temporal contribution of said signal source in the mixed signal or signals, or said digital audio source signal.

14. An information medium comprising the digital audio mixed signal (Sₒᵤₜ) as claimed in claim 14.

15. The information medium of claim 14, wherein the information medium is an audio compact disc.
